(19) United States
(12) Patent Application Publication
(10) Pub. No.: US 2019/0248312 A1
(43) Pub. Date: Aug. 15, 2019

(54) METHODS AND APPARATUS TO FACILITATE WIRELESS TEMPERATURE CONTROL IN A VEHICLE TOUCH POINT

(71) Applicant: Ford Global Technologies, LLC, Dearborn, MI (US)

(72) Inventors: Jordan Furness, Dearborn, MI (US); Ali Hassani, Ann Arbor, MI (US); John Robert Van Wiemeersch, Novi, MI (US)

(21) Appl. No.: 15/894,592

(22) Filed: Feb. 12, 2018

(51) Int. Cl. B60R 16/037; H02J 7/02; B60K 23/00

(52) U.S. Cl. CPC B60R 16/037; B60Y 2400/00; B60K 23/00; H02J 7/025

(57) ABSTRACT

Methods and apparatus to facilitate wireless temperature control in a vehicle touch point are disclosed. An example vehicle comprises a field generator and a shifter. The field generator generates an electromagnetic field. The shifter comprises a receiving inductor, a thermoelectric element, a temperature sensor, and a processor. The receiving inductor generates an electric current from the electromagnetic field. The thermoelectric element is powered by the electric current. The sensor generates temperature information. The processor is configured to control delivery of the electric current to the thermoelectric element based on the temperature information.

### TECHNICAL FIELD

The present disclosure generally relates to vehicle components and, more specifically, methods and apparatus to facilitate wireless temperature control in a vehicle touch point.

### BACKGROUND

In recent years, vehicles have been equipped with heated and/or cooled driver touch point components such as seats and steering wheels. Heated and/or cooled driver touch point components make vehicles more enjoyable to drive and/or improve vehicle comfort. Heated and/or cooled driver touch point components are often engaged by a driver via an interface of a vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example vehicle is disclosed. The vehicle comprises a field generator and a shifter. The field generator generates an electromagnetic field. The shifter comprises a receiving inductor, a thermoelectric element, a temperature sensor, and a processor. The receiving inductor generates an electric current from the electromagnetic field. The thermoelectric element is powered by the electric current. The sensor generates temperature information. The processor is configured to control delivery of the electric current to the thermoelectric element based on the temperature information.

An example method is disclosed. The method comprises: inducing an electric current in a receiving inductor with an electromagnetic field; powering a thermoelectric element with the electric current; generating temperature information with a sensor; and controlling, with a processor, delivery of the electric current to the thermoelectric element based on the temperature information.

An example shifter is disclosed. The shifter comprises a knob, a thermoelectric element, a temperature sensor, and a temperature controller. The knob defines an internal void. The thermoelectric element is disposed in the internal void and connected to the knob. The temperature sensor is disposed in the internal void, is connected to the knob, and generates temperature information. The temperature controller is in communication with the thermoelectric element and the temperature sensor and comprises a receiving inductor and a processor. The receiving inductor generates an electric current from an electromagnetic field. The processor is configured to control delivery of the electric current to the thermoelectric element based on the temperature information.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a schematic view of a vehicle operating in accordance with the teachings of this disclosure in an environment.

FIG. 2 is a schematic view of the shifter and the console of FIG. 1.

FIG. 3 is a block diagram of a temperature controller of the shifter of FIGS. 1 and 2.

FIG. 4 is a block diagram of a wireless charger module of the console of FIGS. 1-3.

FIG. 5 is a block diagram of the electronic components of the vehicle of FIG. 1.

FIG. 6 is a flowchart of a method to control the temperature of the shifter of FIG. 1, which may be implemented by the electronic components of FIG. 5.

### DETAILED DESCRIPTION OF EXAMPLE EMBODIMENTS

While the invention may be embodied in various forms, some exemplary and non-limiting embodiments are shown in the drawings and will hereinafter be described with the understanding that the present disclosure is to be considered an exemplification of the invention and is not intended to limit the invention to the specific embodiments illustrated.

Traditionally, temperature-controlled driver touch point vehicle components include seats and steering wheels. Seats and/or steering wheels are heated or cooled to improve driver comfort and make a vehicle more enjoyable to operate. Seats are often heated using heating elements and cooled using ventilation and/or thermoelectric cooling. Steering wheels are often temperature controlled using thermoelectric heating and cooling. Electrical energy to provide heating and/or cooling to vehicle touch point components is often delivered via a wire harness. Heating and cooling of vehicle touch point components is often engaged by a driver via an interface and/or a climate control system of the vehicle.

This disclosure provides a temperature-controlled vehicle touch point that is electrically heated and cooled by electrical energy delivered wirelessly via induction. The vehicle touch point also incorporates sensors to control the temperature of the vehicle touch point and to stop electrical energy transmission when a driver touches the vehicle touch point. By providing a temperature-controlled vehicle touch point, driver comfort and vehicle enjoyment may be further improved.

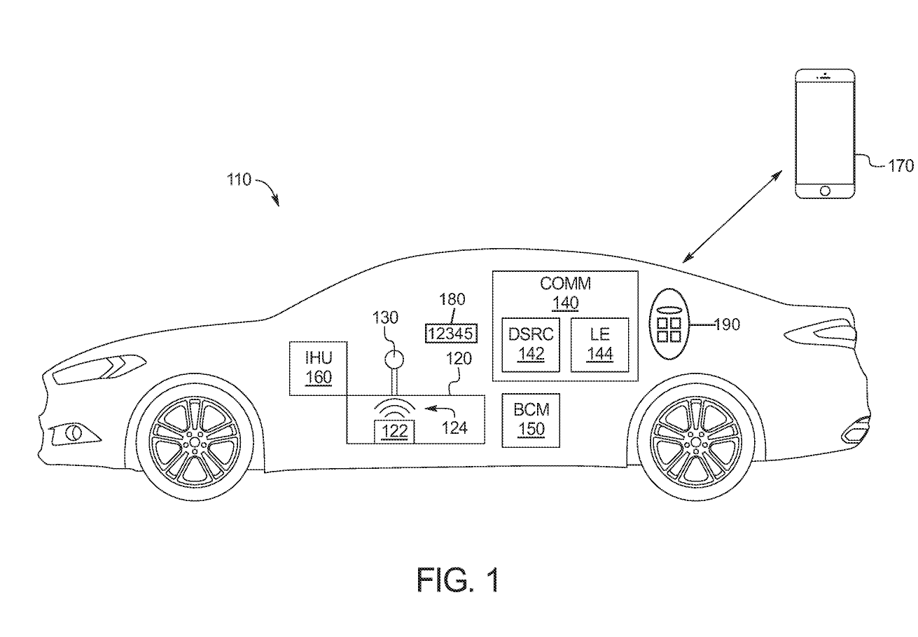

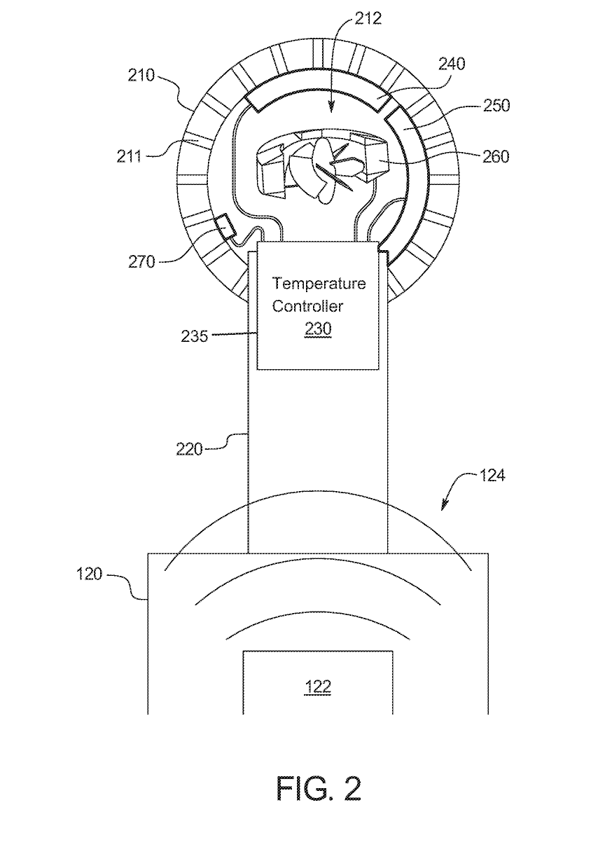

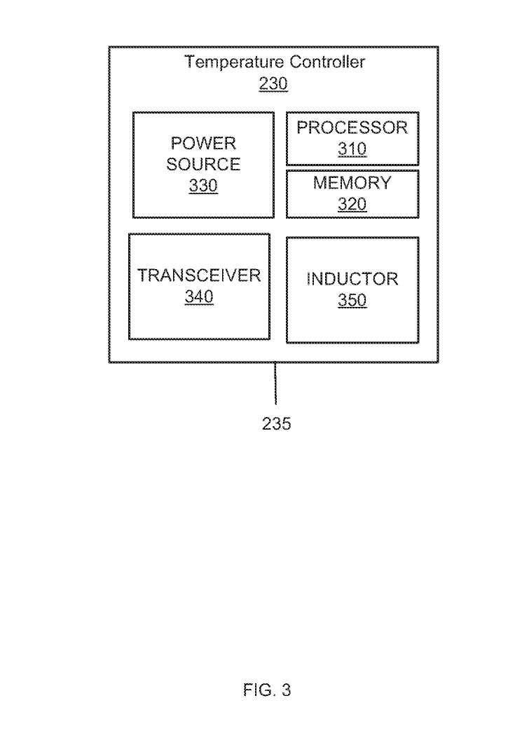

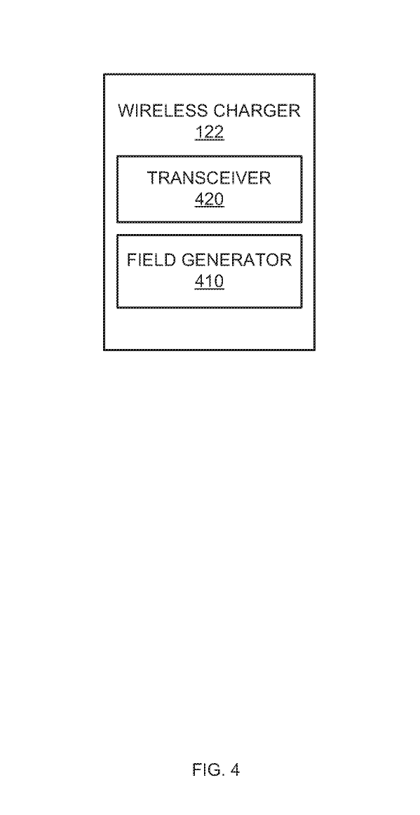

FIG. 1 is a schematic view of a vehicle 110 operating in accordance with the teachings of this disclosure in an environment 100. FIG. 2 is a schematic view of an example shifter 130 and a console 120 of the vehicle 110. FIG. 3 is a block diagram of a temperature controller 230 of the shifter 130. FIG. 4 is a block diagram of a wireless charger module 122 of the console 120.

Referring to FIG., 1, the environment 100 includes the vehicle 110 and a mobile device 170 of a driver. The vehicle 110 may be a standard gasoline powered vehicle, a hybrid vehicle, an electric vehicle, a fuel cell vehicle, and/or any other mobility implement type of vehicle. The vehicle 110 includes parts related to mobility, such as a powertrain with an engine, a transmission, a suspension, a driveshaft, and/or wheels, etc. The vehicle 110 may be non-autonomous, semi-autonomous (e.g., some routine motive functions controlled by the vehicle 110), or autonomous (e.g., motive functions are controlled by the vehicle 110 without direct driver input). As shown in FIG. 1, the vehicle 110 includes the console 120, the shifter 130, a body control module (BCM) 150, an infotainment head unit (IHU) 160, and an external keypad 180. Further, the vehicle is associated with a key fob 190.

In some examples, the vehicle 110 also includes a wireless communication transceiver 140. In such examples, the wireless communication transceiver 140 includes a dedicated short range communication (DSRC) transceiver 142 and a low-energy (LE) transceiver 144. In instances where the mobile device 170 is in range of the LE transceiver 144, the vehicle 110 is in communication with the mobile device 170 via the LE transceiver 144. In instances where the mobile device 170 is out of range of the LE transceiver 144, the vehicle 110 is in communication with the mobile device 170 via the wireless communication transceiver 140. In some examples, the vehicle 110 receives temperature control requests (e.g., inputs, commands, etc.) from the driver via the mobile device 170. Additionally, the wireless communication transceiver 140 is in communication with the key fob 190.

In examples where the vehicle 110 includes the wireless communication transceiver 140, the LE transceiver 144 includes the hardware and firmware to establish a connection with the mobile device 170. In some examples, the LE transceiver 144 implements the Bluetooth and/or Bluetooth Low Energy (BLE) protocols. The Bluetooth and BLE protocols are set forth in Volume 6 of the Bluetooth Specification 4.0 (and subsequent revisions) maintained by the Bluetooth Special Interest Group.

In examples where the vehicle 110 includes the wireless communication transceiver 140, the example DSRC transceiver 142 includes antenna(s), radio(s) and software to broadcast messages and to establish connections between the vehicle 110 and other vehicles, infrastructure-based modules (e.g., a central facility, antennas, etc.), and mobile device-based modules, (e.g., the mobile device 170). In some examples, the vehicle 110 receives temperature control requests (e.g., inputs, commands, etc.) from the mobile device 170 via the DSRC transceiver 142. More information on the DSRC network and how the network may communicate with vehicle hardware and software is available in the U.S. Department of Transportation's Core June 2011 System Requirements Specification (SyRS) report (available at http://www.its.dot.gov/meetings/pdf/CoreSystem_SE_SyRS_RevA%20(2011-06-13).pdf), which is hereby incorporated by reference in its entirety along with all of the documents referenced on pages 11 to 14 of the SyRS report. DSRC systems may be installed on vehicles and along roadsides on infrastructure. DSRC systems incorporating infrastructure information is known as a “roadside” system. DSRC may be combined with other technologies, such as GPS, Visual Light Communications (VLC), Cellular Communications, and short range radar, facilitating the vehicles communicating their position, speed, heading, and relative position to other objects and to exchange information with other vehicles or external computer systems. DSRC systems can be integrated with other systems such as mobile phones.

Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. However, besides the pure DSRC system it is also meant to cover dedicated wireless communication systems between cars and roadside infrastructure system, which are integrated with GPS and are based on an IEEE 802.11 protocol for wireless local area networks (such as, 802.11p, etc.).

The body control module 150 controls various subsystems of the vehicle 110. For example, the body control module 150 may control power windows, power locks, an immobilizer system, and/or power mirrors, etc. The body control module 150 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc.

The infotainment head unit 160 provides an interface between the vehicle 110 and a user. The infotainment head unit 160 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (“LCD”), an organic light emitting diode (“OLED”) display, a flat panel display, a solid state display, etc.), and/or speakers. In the illustrated example, the infotainment head unit 160 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 160 displays the infotainment system on, for example, the center console display. In some examples, the vehicle 110 receives temperature control requests from the driver via the IHU 160. In some examples, the IHU 160 displays received temperature control requests to the driver.

The external keypad 180 locks and unlocks doors of the vehicle 110. In some examples, the vehicle 110 receives temperature control requests from the driver via the external keypad 180. In such examples, the temperature control request may be accomplished via a combination of key presses and/or keys depressed for a threshold time period.

The key fob 190 locks and unlocks doors of the vehicle 110 and controls starting of the vehicle 110. In some examples, the vehicle 110 receives temperature control requests from the driver via the key fob 190 in conjunction with a remote start request from the key fob 190.

Referring to FIGS. 2 and 3, the shifter 130 includes a knob 210, a stalk 220, the temperature controller 230, a touch sensor 240, a thermoelectric element 250, and a temperature sensor 270. In some examples, the shifter 130 also includes a bearingless fan 260.

The knob 210 is hollow to define an internal void 212. The knob 210 further defines perforations 211 to promote airflow through the knob 210. In some examples, the knob 210 is covered in a soft material (e.g., leather, felt, fabric, rubber, synthetic rubber, etc.).

The stalk 220 is connected to a powertrain of the vehicle 110 to control torque delivery from an engine of the vehicle 110 to wheels of the vehicle 110. The stalk 220 supports the knob 210. For example, the knob 210 may be threaded, pressed, glued, bolted, etc. onto the stalk 220.

The temperature controller 230 includes, a processor or controller 310, a memory 320, a power storage source 330 (e.g., a battery, a rechargeable battery, an ultra capacitor, etc.), a transceiver 340, and a receiving inductor 350. In some examples, the temperature controller 230 includes a housing 235. In such examples, the processor 310, the memory 320, the power storage source 330, the transceiver 340, and the receiving inductor 350 are disposed in the housing 235. The temperature controller 230 is supported by the stalk 220 and/or disposed in the internal void 212. In some examples, the temperature controller 230 is in communication with the mobile device 170 via the transceiver 340.

The touch sensor 240 detects the presence of a driver's body part (e.g., a finger, a hand, a forearm, etc.) on the knob 210 and generates touch information. In some examples, the touch sensor 240 is a passive capacitive sensor and is thus not electrically connected to the power storage source 330. It should be appreciated that clothed driver body parts (e.g., a gloved hand, a forearm in a long sleeve, etc.) are detectable by the touch sensor 240, as well as the driver's skin. Thus, in instances where a driver is wearing gloves and/or long sleeves, the driver's touch on the knob 210 is detected by the touch sensor 240. Further, in instances where the driver is bare handed and/or has short sleeves, the driver's touch on the knob 210 is detected by the touch sensor 240. The temperature sensor 270 detects a temperature of the knob 210 and generates temperature information. In some examples, the temperature sensor 270 is a thermocouple. The sensors 240, 270 are connected to the knob 210 and disposed in the internal void 212. The sensors 240, 270 are in communication with the temperature controller 230.

The thermoelectric element 250 is connected to the knob 210 and is disposed in the internal void 212. Further, the thermoelectric element 250 is supported by the stalk 220 and/or the temperature controller 230. The thermoelectric element 250 is powered by the temperature controller 230. In some examples, the thermoelectric element 250 is a Peltier device. In such examples, the thermoelectric element 250 develops a hot side and a cool side under the Peltier effect to heat or cool the knob 210 depending on a direction of an electric current applied to the thermoelectric element 250 by the temperature controller 230. In other words, the temperature controller 230 may deliver the electric current to the thermoelectric element 250 in a first direction to effect a heating mode and in a second direction to effect a cooling mode. Thus, in such examples, the thermoelectric element 250 exchanges heat with the knob 210 and with the stalk 220 and/or temperature controller 230. Thus, in instances where the thermoelectric element 250 cools the knob 210, the stalk 220 acts as a heat sink. In other words, because the thermoelectric element 250 is connected to the knob 210 and the stalk 220 and/or the temperature controller 230, the thermoelectric element 250 moves heat from the knob 210 to the stalk 220 and vice versa. In some examples, the thermoelectric element 250 is a heating element to heat the knob 210.

In examples where the shifter includes the bearingless fan 260, the bearingless fan 260 is disposed in the internal void 212. The bearingless fan 260 is powered by the temperature controller 230. Thus, rotation speed of the bearingless fan 260 is controlled by the temperature controller 230. The bearingless fan 260 increases airflow in the internal void 212 to heat or cool the knob 210 evenly.

Referring to FIGS. 1-4, the console includes a wireless charger module 122. The wireless charger module 122 includes field generator 410. The field generator 410 generates an electromagnetic field 124 to operate as a transmitting inductor. In operation, the electromagnetic field 124 induces an electric current in the receiving inductor 350. The receiving inductor 350 delivers electrical energy to the thermoelectric element 250 to heat or cool the knob 210. In examples where the shifter 130 is equipped with the bearingless fan 260, the receiving inductor 350 delivers electrical energy to power the bearingless fan 260. The power storage source 330 provides energy for the processor 310 to control power delivery from the receiving inductor 350 to the thermoelectric element 250 and, in some examples, bearingless fan 260. Thus, the processor 310 is powered independently of the wireless charger module 122. In some examples, the receiving inductor 350 electrically recharges the power storage source 330.

In some examples, the wireless charger module 122 includes a transceiver 420. In such examples, the wireless charger module 122 is in communication with the temperature controller 230 via the transceiver 340 of the temperature controller 230 and the transceiver 420 of the wireless charger module 122.

In operation, the processor or controller 310 of the temperature controller 230 determines if enabling conditions are met and adjusts electrical power delivery from the receiving inductor 350 to the thermoelectric element 250 based on information from the temperature sensor 270, driver selections from the mobile device 170 received via the wireless communication transceiver 140, driver selections from the IHU 160, and temperature setpoints. The driver selections and temperature setpoints may be stored in the memory 320. In some examples, the temperature setpoints are precise temperatures (e.g., 80 degrees, 72 degrees, 64 degrees, etc.). In some examples, the temperature setpoints are discrete settings (e.g., high heat, medium heat, low heat, high cool, medium cool, low cool, etc.).

More specifically, the processor or controller 310 switches the direction of the electric current from the receiving inductor 350 to implement heating and cooling modes. Further the processor or controller 310 reduces the intensity of the electric current delivered to the thermoelectric element 250 from the receiving inductor 350 to modulate heating and cooling of the knob 210. The processor or controller 310 modulates the intensity of the electric current delivered to the thermoelectric element 250 using, for example, pulse width modulation (PWM), a resistor ladder, etc.

Further in operation, the processor or controller 310 determines whether to send requests to the wireless charger module 122 via the transceiver 340 to energize or de-energize the field generator 410 based on information from the touch sensor 240 and/or driver selections from the mobile device 170 received via the transceiver 340.

Referring to FIGS. 1 and 2, it should be understood and appreciated that the shifter 130 is a particular example of a vehicle touch point of the vehicle 110. It should be further understood that the temperature controller 230, the touch sensor 240, the thermoelectric element 250, the temperature sensor 270, and, in some examples, the bearingless fan 260 may be mounted to any vehicle touch point of the vehicle 110 (e.g., control levers, door handles, a dashboard, armrests, etc.) to provide wirelessly-powered heating and/or cooling to the vehicle touch points. In other words, wirelessly-powered temperature control provided via the temperature controller 230, the touch sensor 240, the thermoelectric element 250, the bearingless fan 260, and the temperature sensor 270 may be applied to any vehicle touch point in the vehicle 110.

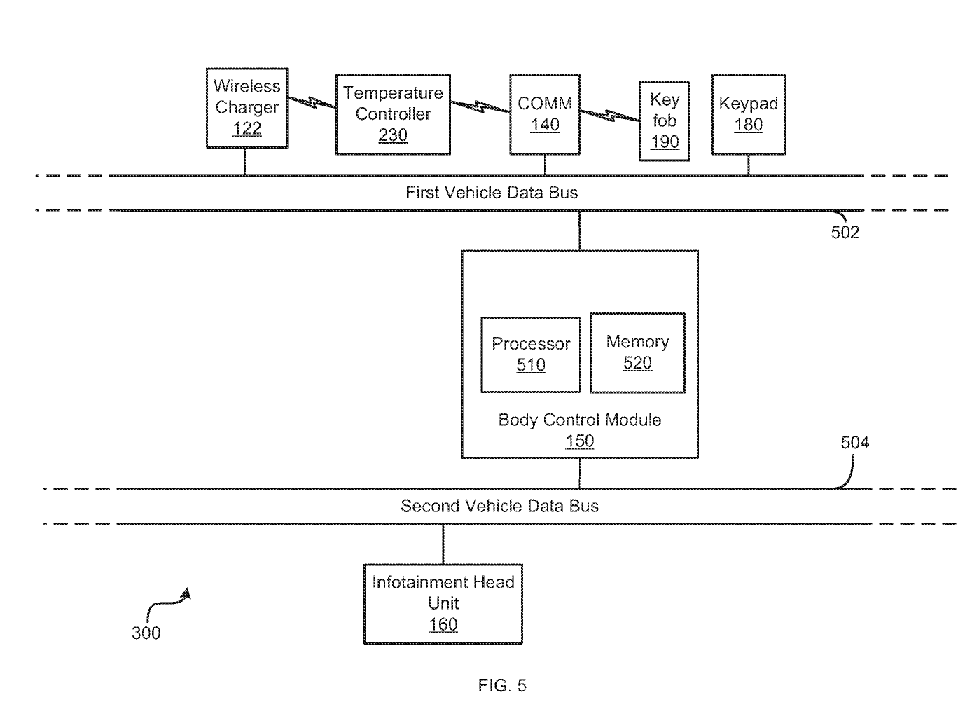

FIG. 5 is a block diagram of the electronic components of the vehicle of FIG. 1. The first vehicle data bus 502 communicatively couples the wireless charger module 122, the wireless communication transceiver 140, the BCM 150, the external keypad 180, and other devices connected to the first vehicle data bus 502. The temperature controller 230 is in wireless communication with the wireless communication transceiver 140 and/or the wireless charger module 122, as shown in FIG. 5. Thus, the temperature controller 230 is in communication with the BCM 150 via the wireless charger module 122 and/or the wireless communication transceiver 140 and the first bus 502. The key fob 190 is in wireless communication with the wireless communication transceiver 140, as shown in FIG. 5. Thus, the key fob 190 is in communication with the BCM 150 the wireless communication transceiver 140 and the first bus 502. In some examples, the first vehicle data bus 502 is implemented in accordance with the controller area network (CAN) bus protocol as defined by International Standards Organization (ISO) 11898-1. Alternatively, in some examples, the first vehicle data bus 402 may be a Media Oriented Systems Transport (MOST) bus, or a CAN flexible data (CAN-FD) bus (ISO 11898-7). The second vehicle data bus 504 communicatively couples the BCM 150 and the infotainment head unit 160. The second vehicle data bus 504 may be a MOST bus, a CAN-FD bus, or an Ethernet bus. In some examples, the BCM 150 communicatively isolates the first vehicle data bus 502 and the second vehicle data bus 504 (e.g., via firewalls, message brokers, etc.). Alternatively, in some examples, the first vehicle data bus 502 and the second vehicle data bus 504 are the same data bus.

The BCM 150 includes a processor or controller 510 and memory 520. In operation, the processor or controller 510 determines whether to energize or de-energize the field generator 410 based on information from the touch sensor 240, the temperature sensor 270, driver selections from the mobile device 170 received via the wireless communication transceiver 140 and driver selections from the IHU 160.

Referring to FIGS. 2 and 5, it should be appreciated that the temperature controller 230, the bearingless fan 260, the thermoelectric element 250, and the sensors 240, 270 are not wired to the console 120. Thus, in some examples, the knob 210 may be removed from the stalk 220 without disconnecting a wire harness. Further, in some examples where a vehicle is originally equipped with a wireless charger module 122 but does not have a temperature-controlled shifter, the knob 210 may be substituted for the vehicle's original shifter knob (e.g., as an after-market accessory, a dealer-installed option, etc.) to customize the vehicle with a temperature-controlled shifter.

Referring to FIGS. 3 and 5, the processors or controllers 310, 510 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memories 320, 520 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc.). In some examples, the memories 320, 520 include multiple kinds of memory, particularly volatile memory and non-volatile memory.

The memories 320, 520 are computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memories 320, 520, the computer readable medium, and/or within the processors 310, 510 during execution of the instructions.

The memory 520 stores driver selections from the mobile device 170 received via the wireless communication transceiver 140, driver selections from the IHU 160, and temperature setpoints. Thus, the temperature controller 230 may provide heating or cooling based on the stored selections and temperature setpoints whenever the vehicle 110 is started. The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

Referring to FIGS. 1-5, in operation, a driver may enter a temperature setpoint to the BCM 150 and the temperature controller 230 via the IHU 160 or via the mobile device 170.

In examples where the vehicle 110 is equipped with the wireless communication transceiver 140, a temperature setpoint from the mobile device 170 is received via the wireless communication transceiver 140 and relayed to the temperature controller 230 via the transceiver 340.

In examples where the vehicle 110 is not equipped with the wireless communication transceiver 140, a temperature setpoint from the mobile device 170 is received via the transceiver 340 of the temperature controller 230. In such examples, the processor 310 of the temperature controller 230 sends the temperature setpoint to the BCM 150 via the transceiver 420 of the wireless charger module 122. In some examples, the BCM 150 sends the temperature setpoint to the IHU 160 for display to the driver

In operation, upon receiving the temperature setpoint, the BCM 150 energizes the field generator 410 to wirelessly induce an electric current in the receiving inductor 350 of the temperature controller 230. In other words, the temperature setpoint from the IHU 160 and/or the mobile device 170 acts as an ON command for the field generator 410. The processor 310 of temperature controller 230 controls the delivery direction and intensity of the induced electric current from the receiving inductor 350 to the thermoelectric element 250. More specifically, in operation, the processor 310 monitors the temperature of the knob 210 based on temperature information from the temperature sensor 270. Further, the processor 310 determines a difference between the temperature information and the temperature setpoint stored in the memory 320. The processor 310 then adjusts power delivery to the thermoelectric element 250 based on the determined difference (e.g., proportionally, etc.). If the temperature of the knob 210 reaches or exceeds the temperature setpoint stored in the memory 320 (e.g., the determined difference is zero or less than zero), the processor 310 pauses delivery of the electric current to the thermoelectric element 250. Thus, the heating or cooling effect of the thermoelectric element 250 is correspondingly reduced.

Further, in operation, the processor 310 monitors whether the driver is touching the knob 210 based on touch information from the touch sensor 240. If the driver is touching the knob 210, the processor 310 sends a de-energize request to the field generator 410 via the transceiver 340 and the first bus 502 to substantially prevent the electromagnetic field 124 from traversing the driver's body. When the driver's body part (e.g., a hand, a forearm, etc.) is no longer touching the knob 210, the processor 310 sends a re-energize request to the field generator 410 via the transceiver 340 and the first bus 502.

Further in operation, a driver may enter an OFF request to the BCM 150 and the temperature controller 230 via the IHU 160 or via the mobile device 170 to turn off temperature control of the shifter 130.

In examples where the vehicle 110 is equipped with the wireless communication transceiver 140, an OFF request from the mobile device 170 is received via the wireless communication transceiver 140 and relayed to the temperature controller 230 via the transceiver 340.

In examples where the vehicle 110 is not equipped with the wireless communication transceiver 140, an OFF request from the mobile device 170 is received via the transceiver 340. In such examples, the processor 310 sends the OFF request to the BCM 150 and for display on the IHU 160 via the transceiver 420 of the wireless charger module 122.

In operation, upon receiving the OFF request, the BCM 150 de-energizes the field generator 410.

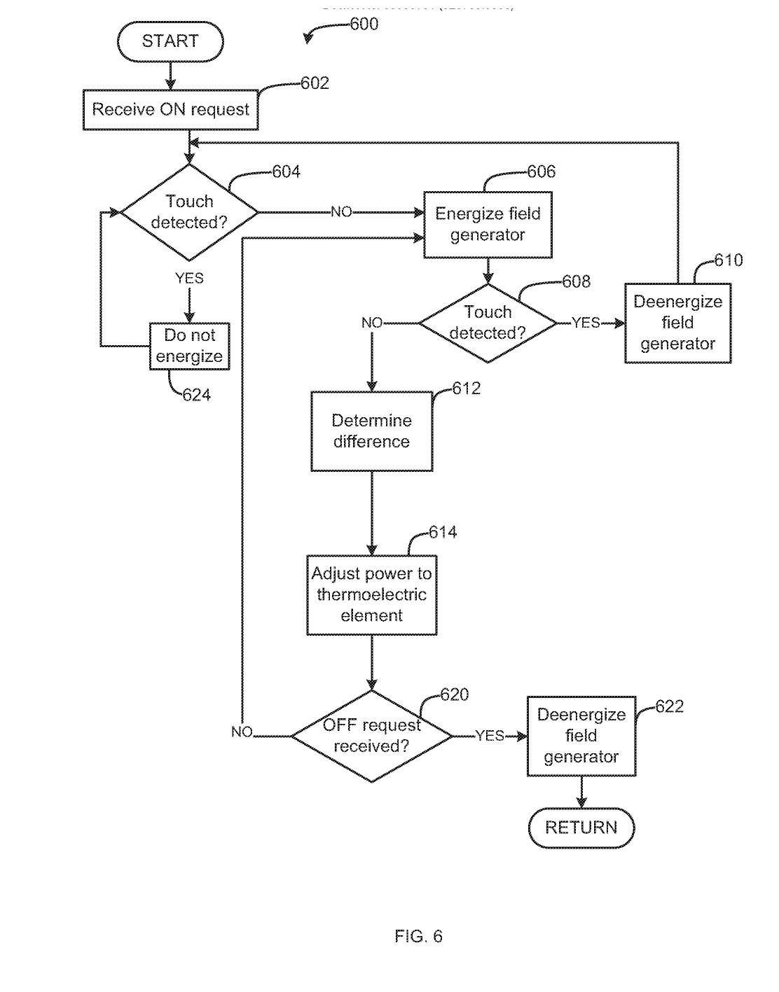

FIG. 6 is a flowchart of a method 600 to control the temperature of the shifter of FIG. 1, which may be implemented by the electronic components of FIG. 5. The flowchart of FIG. 6 is representative of machine readable instructions stored in memory (such as the memories 320, 520 of FIGS. 3 and 5) that comprise one or more programs that, when executed by a processor (such as the processors 310, 510 of FIGS. 3 and 5), cause the vehicle 110 to implement temperature control of the shifter 130 of FIGS. 1 and 2. Further, although the example program(s) is/are described with reference to the flowchart illustrated in FIG. 6, many other methods of implementing temperature control of the shifter 130 may alternatively be used. For example, the order of execution of the blocks may be changed, and/or some of the blocks described may be changed, eliminated, or combined.

Initially, at block 602, the BCM 150 receives an ON request submitted by a driver of the vehicle 110 via the IHU 160 or the mobile device 170. As discussed above, the ON request may be a temperature setpoint. The BCM 150 is in communication with the IHU 160 via the first vehicle data bus 502 and/or the second vehicle data bus 504. In some examples, the BCM 150 is in communication with mobile device 170 via the wireless communication transceiver 140. In some examples, the BCM 150 is in communication with the mobile device 170 via the transceivers 340, 420.

At block 604, the processor 310 of the temperature controller 230 determines whether a driver is touching the knob 210 based on touch information from the touch sensor 240. As discussed above, the touch sensor 240 is in communication with the temperature controller 230.

If, at block 604, the processor 310 determines that the driver is not touching the knob 210, the processor 310 sends an energize request to the BCM 150 via the transceiver 340. The method 600 then proceeds to block 606.

At block 606, the BCM 150 energizes the field generator 410 to begin transmitting the electromagnetic field 124. The method 600 then proceeds to block 608.

If, at block 604, the processor 310 determines that the driver is touching the knob 210, the processor 310 sends a do not energize request to the BCM 150 via the transceiver 340. The method 600 then proceeds to block 624.

At block 624, the BCM 150 receives the do not energize request from the processor 310 and does not energize the field generator 410 despite the ON request. The method 600 then returns to block 604. In other words, the BCM 150 waits for confirmation from the processor 310 that the driver is not touching the knob 210 to energize the field generator 410 at block 606.

At block 608, processor 310 of the temperature controller 230 re-determines whether a driver is touching the knob 210 based on touch information from the touch sensor 240.

If, at block 608, the processor 310 determines that the driver is not touching the knob 210, the method 600 proceeds to block 612.

If, at block 608, the processor 310 determines that the driver is touching the knob 210, the processor 310 sends a de-energize request to the BCM 150 via the transceiver 340. The method 600 then proceeds to block 610.

At block 610, the BCM 150 receives the de-energize request from the processor 310 and de-energizes the field generator 410. The method 600 then returns to block 604. Thus, by executing the blocks 604, 606, 608, 610 the processor 310 monitors whether the driver is touching the knob 210 for the BCM 150 to energize and de-energize the field generator 410.

At block 612, the processor 310 determines a difference between the temperature set point and the temperature information from the temperature sensor 270. As discussed above, the temperature sensor 270 is in communication with the temperature controller 230. More specifically, the processor 310 compares the temperature information to the temperature setpoint stored in the memory 320.

At block 614, the processor 310 adjusts power delivery from the receiving inductor 350 of the temperature controller 230 to the thermoelectric element 250 based on the determined difference (block 612). As discussed above, the thermoelectric element 250 is driven by the temperature controller 230. More specifically, the processor 310 adjusts the intensity of the electric current provided to the thermoelectric element 250 based on the determined difference to correspondingly reduce heating or cooling of the thermoelectric element 250. In some examples, when the temperature setpoint is reached, the processor 310 pauses (e.g., temporarily stops, etc.) delivery of the electric current provided to the thermoelectric element 250

At block 620, the BCM 150 determines whether an OFF request has been received via the IHU 160 or the mobile device 170.

If, at block 620, the BCM 150 determines that an OFF request has not been received, the method 600 returns to block 606, where the BCM 150 continues to energize the field generator 410.

If, at block 620, the BCM 150 determines that an OFF request has been received, the method 600 proceeds to block 622.

At block 622, the BCM 150 de-energizes the field generator 410. The method 600 then returns to block 602.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

From the foregoing, it should be appreciated that the above disclosed apparatus and methods may provide temperature control to a shifter of a vehicle. By controlling the temperature of an often-touched vehicle component such as a shifter, vehicle comfort may be improved and driving the vehicle may be more enjoyable. It should also be appreciated that the disclosed apparatus and methods provide a specific solution—reducing power delivery from a receiving inductor to a thermoelectric element based on temperature information and energizing and de-energizing a field generator based on touch information—to a specific problem—wirelessly heating and/or cooling a shifter only while the shifter is not being touched.

As used here, the terms “module” and “unit” refer to hardware with circuitry to provide communication, control and/or monitoring capabilities, often in conjunction with sensors. “Modules” and “units” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a field generator to generate an electromagnetic field; and
a shifter comprising:
a receiving inductor to generate an electric current from the electromagnetic field;
a thermoelectric element powered by the electric current;
a sensor to generate temperature information; and
a processor configured to control delivery of the electric current to the thermoelectric element based on the temperature information.

2. The vehicle of claim 1, wherein:
the processor is a first processor; and
the shifter comprises a touch sensor to generate touch information; and further comprising:
a second processor configured to control the field generator based on the touch information.

3. The vehicle of claim 2, wherein:
the second processor energizes the field generator when the touch information indicates that a driver is not touching the shifter; and
the second processor de-energizes the field generator when the touch information indicates that the driver is touching the shifter.

4. The vehicle of claim 1, wherein the shifter comprises:
a transceiver to receive a temperature setpoint; and
a memory to store the temperature setpoint.

5. The vehicle of claim 4, further comprising an infotainment head unit (IHU) and wherein the temperature setpoint is received from the IHU or a mobile device.

6. The vehicle of claim 4, wherein the processor is configured to determine a difference between the temperature information and the temperature setpoint.

7. The vehicle of claim 6, wherein, the processor is configured to reduce power delivery to the thermoelectric element based on the difference.

8. The vehicle of claim 1, wherein the processor is configured to
deliver the electric current to the thermoelectric element in a first direction to effect a heating mode; and
deliver the electric current to the thermoelectric element in a second direction to effect a cooling mode.

9. A method comprising:
inducing an electric current in a receiving inductor with an electromagnetic field;
powering a thermoelectric element with the electric current;
generating temperature information with a sensor; and
controlling, with a processor, delivery of the electric current to the thermoelectric element based on the temperature information.

10. The method of claim 9, wherein the processor is a first processor and further comprising:
generating touch information with a touch sensor;
generating the electromagnetic field with a field generator; and
controlling, with a second processor, the field generator based on the touch information.

11. The method of claim 10, wherein controlling, with the second processor, the field generator based on the touch information comprises:
energizing, with the second processor, the field generator when the touch information indicates that a body part of a driver is not detected; and
de-energizing, with the second processor, the field generator when the touch information indicates that the body part of the driver is detected.

12. The method of claim 9, further comprising:
receiving a temperature setpoint with a transceiver; and
storing the temperature setpoint in a memory.

13. The method of claim 12, further comprising comparing, with the processor, the temperature information to the temperature setpoint.

14. The method of claim 13, wherein controlling delivery of the electric current to the thermoelectric element based on the temperature information further comprises adjusting, with the processor, power delivery to the thermoelectric element based on a difference between the temperature information and the temperature setpoint.

15. The method of claim 9, wherein controlling delivery of the electric current to the thermoelectric element based on the temperature information further comprises:
delivering, with the processor, the electric current to the thermoelectric element in a first direction to effect a heating mode; and
delivering, with the processor, the electric current to the thermoelectric element in a second direction to effect a cooling mode.

16. A shifter comprising:
a knob defining an internal void;
a thermoelectric element disposed in the internal void and connected to the knob;
a temperature sensor disposed in the internal void and connected to the knob to generate temperature information; and
a temperature controller in communication with the thermoelectric element and the temperature sensor and comprising:
a receiving inductor to generate an electric current from an electromagnetic field; and
a processor configured to control delivery of the electric current to the thermoelectric element based on the temperature information.

17. The shifter of claim 16, wherein the temperature controller comprises:
a transceiver to receive a temperature setpoint from at least one of an infotainment head unit (IHU) or a mobile device; and
a memory to store the temperature setpoint.

18. The shifter of claim 17, wherein the processor is configured to:
deliver the electric current to the thermoelectric element in a first direction to effect a heating mode; and
deliver the electric current to the thermoelectric element in a second direction to effect a cooling mode.

19. The shifter of claim 16, further comprising a touch sensor connected to the knob to generate touch information.

20. The shifter of claim 19, wherein the processor is configured to send a de-energize request to a body control module (BCM) to stop generation of the electromagnetic field when the touch information indicates that a driver is touching the knob.
